(19) United States
(12) Patent Application Publication
(10) Pub. No.: US 2022/0092512 A1
(43) Pub. Date: Mar. 24, 2022

(54) SYSTEM AND METHOD FOR DISTRIBUTING AN AGENT INTERACTION TO THE EVALUATOR BY UTILIZING HOLD FACTOR

(71) Applicant: NICE LTD, Ra'anana (IL)

(72) Inventors: Salil DHAWAN, Pune (IN); Rahul VYAS, Jodhpur (IN)

(21) Appl. No.: 17/026,316

(22) Filed: Sep. 21, 2020

(51) Int. Cl. G06Q 10/06; G06N 5/02

(52) U.S. Cl. CPC G06Q 10/06398; G06N 5/022

(57) ABSTRACT

A computerized-method for calculating a hold factor of an interaction in a call center, by which related agent recording segments may be filtered for evaluation is provided herein. The computerized-method include: operating a Hold Factor Calculation (HFC) model for an interaction. The HFC model include receiving agent recording segments of the interaction and then collecting data fields of: (i) skills of agent; and (ii) interaction metadata. Then, checking to determine if hold time has occurred in the received agent recording segments and when it is determined that hold time has occurred the HFC is: (a) calculating a hold-ratio; (b) calculating a conversation score based on the collected data fields; (c) dividing the calculated hold ratio by the calculated conversation score to yield a hold factor; and (d) sending the yielded hold factor to a quality planner microservice by which the quality planner is preconfigured to distribute the interaction for evaluation.

### TECHNICAL FIELD

The present disclosure relates to the field of data analysis to filter agent recording segments for evaluation in a quality management process, according to a calculated factor.

### BACKGROUND

Modern call centers generate a complex hives of data, and the task of mining through all the data to assess the effectiveness and efficiency of the agents and their processes may not be an easy task. As more data is processed, the risk of losing important information rises, yet this information might be crucial for quality management measurement and improvement.

To deliver better service to their customers, current systems in contact centers monitor all agents' interactions and accordingly based on an evaluation of the monitored interactions, build coaching plans for the agents to improve their performance. Moreover, current systems in contact centers maintain a platform with quality management plans which automatically receive interactions for agents' performance evaluation, randomly or based on business preferences. These systems further maintain automate alerts and distribution of work for evaluations, disputes, calibrations and coaching. To improve the effectiveness of coaching tools, coaching is delivered based on an evaluation of a single interaction or based on the evaluation of trends that might affect business-driven Key Performance indicators (KPIs).

A Key Performance Indicator (KPI) is a measurable value that demonstrates how effectively an organization is achieving key business objectives. For example, low-level KPIs may focus on processes in individual departments or teams.

One of the top call center KPIs to measure success is “hold time”. Hold time is the total amount of time a caller spends in an agent-initiated hold status. In other words, hold time is when the caller connects with an agent, and typically they have some discussion, and then the agent puts them on hold, meaning the call is not disconnected but the caller is in a sort of limbo until the agent takes them back off hold. Agents can put callers on hold for a variety of reasons, ranging from a need to ask their supervisor for help to resolve the caller's issue to the need to cool down because the caller is very angry.

Hold time is a call center KPI that is based on the amount of time, commonly measured in seconds. It measures how much time an agent keeps a caller on hold during a call. It may also include the time that was needed for the agent to look something up or to talk to someone else to resolve the caller's issue.

Keeping a call on hold for an extended period may result in decreased contact center efficiency as well as degraded customer experience which is aggravating for customers. That is why, hold time is a measurement that contact centers strive to manage and keep to minimum. When it is higher than expected value, e.g., out of variance, it is probably a symptom that one or more agent related processes needs to be investigated and addressed.

However, hold time should not be the only indicator of agent efficiency measurement, it should also be considered against other variable factors such as agent related e.g., skill set of the agent and factors which are associated with the call, e.g., call complexity and total duration or the number of hold times, to aid an evaluator of an interaction to determine which areas of expertise need improvement, i.e., further consideration to follow-on remedial measures as part of a quality management process.

Accordingly, there is a need for a technical solution that will consider hold time against agent and call characteristics by calculating a hold factor of an interaction in a call center, by which related relevant agent recording segments of an interaction may be filtered for evaluation. In the evaluation an evaluator may listen back through the filtered agent recording segments and may spot trends in what lead to the interaction or call being placed on hold.

Thus, the needed technical solution may enable improvements in key areas such as inefficient processes which are slower than in expected processes, lack of refresher trainings, high attrition rate and inefficient knowledge base may directly come to limelight.

### SUMMARY

There is thus provided, in accordance with some embodiments of the present disclosure, a computerized-method for calculating a hold factor of an interaction in a call center, by which related agent recording segments may be filtered for evaluation.

Furthermore, in accordance with some embodiments of the present disclosure, in a computerized system comprising a processor, a database of historical data related to interaction metadata and skills of agent, a database of interaction metadata; a memory to store the plurality of databases, the processor may be configured to operate a Hold Factor Calculation (HFC) model for an interaction.

Furthermore, in accordance with some embodiments of the present disclosure, the operating of HFC model may include: (a) receiving agent recording segments of the interaction; (b) collecting data fields of: (i) skills of agent stored in the database of historical data; and (ii) interaction metadata stored in the database of interaction metadata and in the database of historical database; and (c) checking to determine if hold time has occurred in the received agent recording segments.

Furthermore, in accordance with some embodiments of the present disclosure, when it is determined that hold time has occurred: the operating of the HFC model may further include: (a) calculating a hold ratio; (b) calculating a conversation score based on the collected data fields; (c) dividing the calculated hold ratio by the calculated conversation score to yield a hold factor; and (d) sending the yielded hold factor to a quality planner microservice by which the quality planner is preconfigured to distribute the interaction for evaluation.

Furthermore, in accordance with some embodiments of the present disclosure, when it is determined that hold time has not occurred hold factor is zeroed.

Furthermore, in accordance with some embodiments of the present disclosure, the hold ratio may be calculated by: (a) identifying one or more hold times in each segment of the received agent recording segments to measure a duration of each identified hold time and to sum the measured duration of the one or more hold times to a total hold time in the interaction; (b) measuring a total duration of the received agent recording segments of the interaction; and (c) calculating a hold ratio by diving the total hold time by the total duration.

Furthermore, in accordance with some embodiments of the present disclosure, the conversation score may be calculated by: (a) calculating a weighted average of the collected skills of agent data fields to yield an aggregated skills score; (b) assigning a skill-set level based on the yielded aggregated skills score according to a preconfigured table level of skill-set; (c) calculation a weighted average of the collected interaction data fields to yield an aggregated complexity score; (d) assigning complexity-level of the interaction based on the yielded aggregated complexity score according to a preconfigured table level of complexity; (e) calculating a total duration of allowed hold times based on the assigned score for skill-set of an agent and based on the determined complexity-level of the interaction; and (f) summing the assigned score for skill-set of an agent, the determined complexity-level and the calculated total number of allowed hold timed to yield a conversation score.

Furthermore, in accordance with some embodiments of the present disclosure, the data fields of skills of agent may include at least one of: proficiency level; First Call Resolution (FCR) rate; technical expertise; patience; resourcefulness; multitasking; and other or any combination thereof.

Furthermore, in accordance with some embodiments of the present disclosure, the data fields of interaction may include at least one of: Average Handling Time (AHT); timeline of customer ticket; complexity of customer questions and concerns; number of agents involved in the interaction; and other or any combination thereof.

Furthermore, in accordance with some embodiments of the present disclosure, the distributed interaction for evaluation is reviewed by an evaluator for due consideration and follow-on remedial measures to enhance call centre and agent's efficiency.

Furthermore, in accordance with some embodiments of the present disclosure, the due consideration is selected from at least one of: (i) identifying low level of performance of agents; (ii) identifying high attrition rate; and (iii) identifying ineffective knowledge base.

Furthermore, in accordance with some embodiments of the present disclosure, the follow-on remedial measures are selected from at least one of: (i) assigning agents to a coaching plan based on the identified low level of performance; (ii) solving related issues to agents discontent; and (iii) amending the knowledge base to be effective for the interactions.

Furthermore, in accordance with some embodiments of the present disclosure, the yielded hold factor is a value between zero and one, and wherein when the value is closer to one it is an indication that the call center is not efficient.

There is further provided, in accordance with some embodiments of the present disclosure, a computerized-system for calculating a hold factor of an interaction in a call center, by which related agent recording segments may be filtered for evaluation.

Furthermore, in accordance with some embodiments of the present disclosure, the computerized-system may include: a database of historical data related to interactions and skills of agent; a database of interaction metadata; a memory to store the plurality of databases; and a processor. The processor may be configured to operate a Hold Factor Calculation (HFC) model for an interaction

Furthermore, in accordance with some embodiments of the present disclosure, the operating of the HFC may include: (a) receiving agent recording segments of an interaction; (b) collecting data fields of: (i) skills of agent stored in the database of historical data; and (ii) interaction metadata stored in the database of interaction metadata and in the database of historical database; and (c) checking to determine if hold time has occurred in the received agent recording segments.

Furthermore, in accordance with some embodiments of the present disclosure, when it is determined that hold time has occurred the HFC model may further (a) calculate a hold ratio; (b) calculate a conversation score; (c) divide the calculated hold ratio by the calculated conversation score to yield a hold factor; and (d) send the yielded hold factor to a quality planner microservice by which the quality planner is preconfigured to distribute the interaction for evaluation.

Furthermore, in accordance with some embodiments of the present disclosure, when it is determined that hold time has not occurred hold factor is zeroed.

Furthermore, in accordance with some embodiments of the present disclosure, the hold ratio may be calculated by: (a) identifying one or more hold times in each segment of the received agent recording segments to measure a duration of each identified hold time and to sum the measured duration of the one or more hold times to a total hold time in the interaction; (b) measuring a total duration of the received agent recording segments of the interaction; and (c) calculating a hold ratio by dividing the total hold time by the total duration.

Furthermore, in accordance with some embodiments of the present disclosure, the conversation score may be calculated by: (a) calculating a weighted average of the collected skills of agent data fields to yield an aggregated skills score; (b) assigning a skill-set level based on the yielded aggregated skills score according to a preconfigured table level of skill-set; (c) calculation a weighted average of the collected interaction data fields to yield an aggregated complexity score; (d) assigning complexity-level of the interaction based on the yielded aggregated complexity score according to a preconfigured table level of complexity; (e) calculating a total duration of allowed hold times based on the assigned score for skill-set of an agent and based on the determined complexity-level of the interaction; and (f) summing the assigned score for skill-set of an agent, the determined complexity-level and the calculated total number of allowed hold timed to yield a conversation score.

Furthermore, in accordance with some embodiments of the present disclosure, the data fields of skills of agent may include at least one of: proficiency level; First Call Resolution (FCR) rate; technical expertise; patience; resourcefulness; multitasking; and other or any combination thereof.

Furthermore, in accordance with some embodiments of the present disclosure, the data fields of interaction may include at least one of: Average Handling Time (AHT); timeline of customer ticket; complexity of customer questions and concerns; number of agents involved in the interaction; and other or any combination thereof.

Furthermore, in accordance with some embodiments of the present disclosure, the distributed interaction for evaluation is reviewed by an evaluator for due consideration and follow-on remedial measures to enhance call centre and agent's efficiency.

Furthermore, in accordance with some embodiments of the present disclosure, the due consideration is selected from at least one of: (i) identifying low level of performance of agents; (ii) identifying high attrition rate; and (iii) identifying ineffective knowledge base.

Furthermore, in accordance with some embodiments of the present disclosure, the follow-on remedial measures are selected from at least one of: (i) assigning agents to a coaching plan based on the identified low level of performance; (ii) solving related issues to agents discontent; and (iii) amending the knowledge base to be effective for the interactions.

Furthermore, in accordance with some embodiments of the present disclosure, the yielded hold factor is a value between zero and one, and wherein when the value is closer to one it is an indication that the call center is not efficient.

### BRIEF DESCRIPTION OF THE DRAWINGS

FIG. 1 schematically illustrates a high-level diagram of distribution of agent interaction for evaluation based on hold factor, in accordance with some embodiments of the present disclosure;

FIGS. 2A-2B is a diagram of a system for calculating a hold factor of an interaction in a call center, by which related agent recording segments may be filtered for evaluation, according to some embodiments of the disclosure;

FIGS. 3A-3B is a high-level workflow of Hold Factor Calculation (HFC) model for calculating a hold factor of an interaction in a call center, by which related agent recording segments may be filtered for evaluation, in accordance with some embodiments of the present disclosure;

FIG. 4 schematically illustrates a calculation of hold ratio, in accordance with some embodiments of the present disclosure;

FIG. 5 a table illustrating parameters for calculation of a conversation score based on agent and interaction characteristics, according to some embodiments of the present disclosure;

FIGS. 6A-6D illustrate data fields related to skills of agent to calculate a skillset score, according to some embodiments of the present disclosure; and

FIGS. 7A-7D illustrate data fields related to an interaction to calculate interaction complexity score, according to some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The terms “interaction” and “call” are interchangeable.

The terms “call center” and “contact center” are interchangeable.

The terms “caller” and “customer” and “client” are interchangeable.

The term “Net Promoter Score” as used herein refers to a management tool that can be used to gauge the loyalty of a firm's customer relationships.

The term “skill” as used herein refers to a skill that is required to conduct an interaction with the customer. For example, Spanish as a mother-tongue for Spanish speaking customers or credit-card for customers who require service that is related to credit card issues.

The term “Proficiency level” as used herein refers to an indication of the agent's experience or strengths during the handling of a call.

The term “First Call resolution (FCR) rate” as used herein refers to agent capability to resolve the customer issues in the first attempt.

The term “communication” as used herein refers to the ability to keep conversations clear and productive which helps both in resolving clients' issues as well as making a good impression.

The term “Technical expertise” as used herein refers to the domain expertise of an agent. It refers to agent's in-depth knowledge of the company's products and services, as well as of common complaints and their solutions which can make a world of difference in the customer's experience.

The term “Patience” as used herein refers to agent's ability to allow customers the time they need to explain their concerns and actively assist along the way.

The term “Resourcefulness” as used herein refers to the ability of an agent to quickly figure out a solution that will temporarily satisfy a customer until a larger fix can be made to rectify a more extensive problem for a situation when a customer service crops up and requires improvisation and adaptability.

The term “Multitasking” as used herein refers to customer service when agents manage more than one customer conversation at a time on digital channels. This is a combination of agent's skill and expertise to ensure customers aren't waiting extended periods of time between responses.

The term “holds” as used herein refers to putting a customer on hold during an interaction with an agent to search for a resolution to an issue that the customer has raised.

The term “Elastic Load Balancing (ELB)” as used herein refers to a load-balancing service in a cloud-based computing environment such as Amazon Web Services (AWS) deployments. ELB automatically distributes incoming application traffic and scales resources to meet traffic demands. The ELB may be attached for each Micro-Service (MS) instance. In a non-limiting example, for each database such as MySQL instance an ELB may be attached to it. The purpose of automatic scaling is to automatically increase the size of Auto Scaling group when demand for resources goes up and to decrease it when demand goes down. As capacity is increased or decreased, the Amazon EC2 instances being added or removed must be registered or deregistered with a load balancer. This enables an application to automatically distribute incoming web traffic across such a dynamically changing number of instances.

The term “Elastic Search” (ES) as used herein refers to a document-oriented database designed to store, retrieve, and manage document-oriented or semi-structured data. The recording data is stored inside elastic search in JSON document form. In order to store JSON document data inside elastic search Index Application Programming Interface (API) may be used.

The term “Session Border Controller (SBC)” as used herein refers to a dedicated device that protects and regulates IP communications flows. SBCs are used to regulate all forms of real-time communications including VoIP, IP video, text chat and collaboration sessions. SBCs manipulate IP communications signaling and media streams, providing a variety of functions including security, Multivendor Interoperability, Protocol Interworking, Quality of Service (QoS), and Session Routing.

The term “Micro Service (MS)” as used herein refers to an instance that is facilitated in an MS architecture which is supporting high availability and auto scaling of computing resources. Each MS is installed inside a docker container such as instance of Amazon's Elastic Compute Cloud (EC2). Amazon EC2 instance is a virtual server in EC2 for running applications on Amazon Web Services (AWS) infrastructure. Each MS is having at least two instances or can be configured to have many instances to provide high availability of computing resources solution with different configurations of Central Processing Unit (CPU), memory, storage and networking resources to accommodate user needs.

For every MS instance there is attached an Elastic Load Balancer (ELB). ELB is a computing resources load-balancing service for AWS deployments. ELB automatically distributes incoming application traffic and scales computing resources to meet computing traffic demands. The purpose of automatic scaling is to automatically increase the size of auto scaling group when demand for computing resources goes up and decreases the size of auto scaling group when demand for computing resources goes down.

As the capacity of AWS increases or decreases, the Amazon EC2 instances which are being added or removed must be registered or deregistered with a load balancer. This enables an application that is receiving computing resources from AWS to automatically distribute incoming web traffic across a dynamically changing number of instances.

The term “Amazon Kinesis Data Streams (KDS)” as used herein refers to a service that is used to collect and process large streams of data records in real-time.

The term “Quality Planner (QP)” as used herein refers to a Micro Service (MS) that enables quality plans management from a centralized location. Quality plans may randomly select agent interactions based on predefined criteria, and then distribute those interactions to evaluators for evaluation and review. After a quality plan is created and activated by the QPMS, it samples interactions from the agents which are defined in the quality plan and send the relevant segments to evaluators for review. When a Quality Plan is created it is provided with a data range of the duration of the interaction call between an agent and a customer. Based on that data range, voice recording segments of call interactions may be retrieved from document-oriented tables in the cloud-based computing environment. For example, when retrieving x interactions of agent x, y interactions of agent y, z interactions of agent z and so on from the database in the cloud-based computing environment, the QP may randomly select any agent from the retrieved agents and then apply filter criteria to distribute the interaction call to an evaluator which is one of a plurality of evaluators.

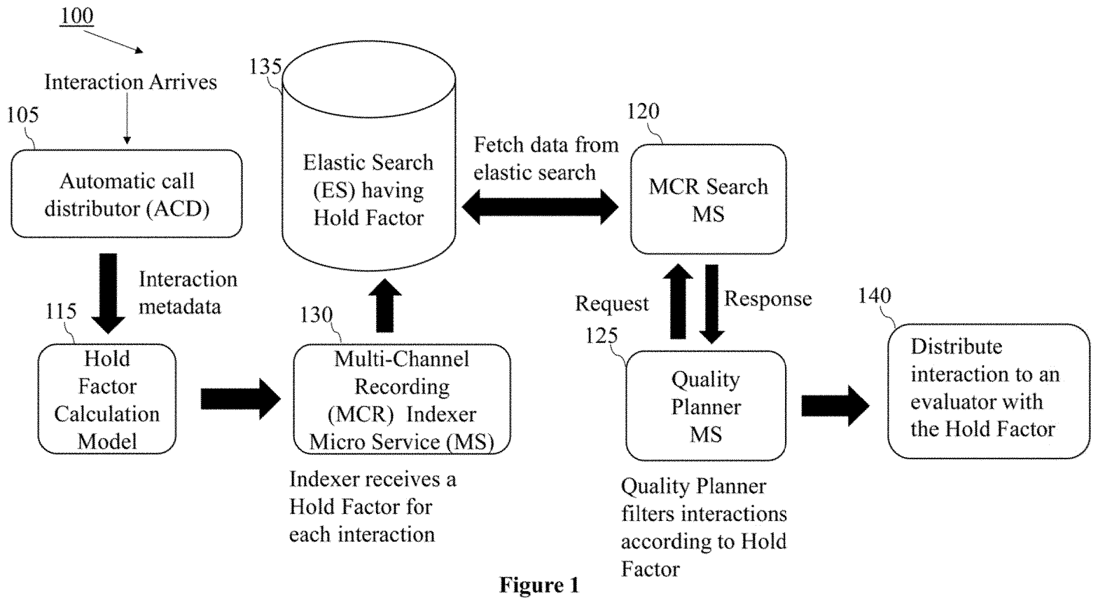

The QP MS may be used to distribute segments across evaluators as per the configuration of the QP. A scheduled job may run as per the configuration in the configuration file e.g., every two hours, and may distribute the agent recording segments evenly among all evaluators. Whenever a manager creates a new QP then QP MS calls MCR Search MS such as MCR search MS 120 in FIG. 1, which queries the elastic search to get the segment records of the agent as per the date range. The QP MS will fetch the interaction stored inside the elastic search as per the hold factor range provided by the manager and send such interactions to the evaluator for the evaluation purpose.

The term “MySQL” as used herein refers to a table-oriented database.

The term “Amazon Web Services (AWS)” as used herein refers to a service of an on-demand cloud computing platforms that Amazon provides.

The term “Elastic Compute Cloud (EC2)” as used herein refers to a scalable computing capacity in the AWS cloud.

The term “Sticky Session Manager (SSM)” as used herein refers to a generic router responsible for routing an event to the same target. Routing an event to the same target is important because an event that is received from a cloud base center such as InContact core should be forwarded to the same Interaction Management (IM) instance. For every SSM a ELB service is attached to it for scaling purposes.

The term “Interaction Manager (IM) service” as used herein refers to a microservice that is responsible for events (CTI/CDR) which are received from the call center through SSM. The main purpose of this service is to manage the state of every Computer Telephony Integration (CTI) call event and send a recording request to the relevant recorder. Once the call is finished, the IM sends the segment to the Kinesis data stream.

The term “Public Switched Telephone Network (PSTN)” as used herein refers to the aggregate of the world's circuit-switched telephone networks that are operated by national, regional, or local telephone operators, and providing infrastructure and services for public telecommunication.

The embodiments taught herein relating to contact interactions in a Contact Center (CC) with contact interactions between a customer and an agent i.e., a CC representative is merely shown by way of example and technical clarity, and not by way of limitation of the embodiments of the present disclosure. The embodiments herein for effective coaching by automatically pointing on an influencer on measured performance may be applied on any customer service channel such as, Interactive Voice Response (IVR) or mobile application. Furthermore, the embodiments herein are not limited to a CC but may be applied to any suitable platform that is providing customer service channels.

Call centers constantly monitor interactions between customers and agents in the call center for later evaluation. The purpose of the evaluation is to identify low level performance of the agents and accordingly to tailor training and coaching programs to the agents to enhance their performance or alternatively identify deficiencies in the knowledgebase and amend it. Since there is a large number of interactions in a specified period of time and it is not applicable to evaluate all interactions, and because there are interactions which their evaluation might be more effective than others for evaluation purposes, the interactions are filtered before they are sent for evaluation.

Commonly, there is a quality plan component in call center systems which filters interactions between agents and clients before they are sent for evaluation. The quality plan component aims to reveal which areas of expertise need improvement by various factors and accordingly one or more training programs are assigned to the agents to increase their performance or alternatively the knowledgebase is amended to include missing data.

To improve contact center efficiency, if for example a hold factor can be tracked and optimized, and calls can be shortened by at least 30 seconds. Then, for a call center that takes 20,000 calls a month, that's a savings of 10,000 minutes, or about 167 call agent hours, every month. This is a productivity increase and it's the equivalent of boosting the agent workforce by 25%.

Inefficiencies of a contact center may be reflected in high hold factor and inline impacting key call center KPI's. When the hold factor is too high, an analysis of the interactions may reveal system issues such as outdated knowledgebase or inefficient agent performance. Accordingly, the knowledgebase may be updated to meet agents needs or an effective coaching plan may be tailored to improve agents' performance. Improved agents' performance may also result in higher job satisfaction and increase of agents' efficiency, i.e., more calls being answered, resulting in efficient contact centers.

Lowering hold factor may result in improved customer experience and an increased customer satisfaction, which may enhance call experience and lower customer abandonment rate.

The improvement may also be reflected in Net Promoter Score (NPS) which is a metric used to measure customer loyalty and satisfaction.

According to some embodiments of the present disclosure, the hold factor may be utilized as a filter during a distribution of a recorded agent interaction to an evaluator, based on a hold factor that may be set by a manager. A recorded interaction may be filtered and distributed to an evaluator and accordingly the evaluator may use this factor for evaluating such interactions.

According to some embodiments of the present disclosure, a hold factor may be calculated by considering total hold time incurred by an agent per interaction duration i.e., hold ratio against conversation score of the conversation. The conversation score may be calculated as per the skill set of agents, call complexity and total number of holds involved during the conversation so that accordingly the hold factor may be calculated. The skill set of the agent may include at least one of: proficiency level; First Call Resolution (FCR) rate; technical expertise; patience; resourcefulness; multitasking; and other or any combination thereof.

According to some embodiments of the present disclosure, the calculation of a call complexity may be based on at least one of: Average Handling Time (AHT); timeline of customer ticket; complexity of customer questions and concerns; number of agents involved in the interaction; and other or any combination thereof.

FIG. 1 schematically illustrates a high-level diagram of a system 100 for distribution of agent interaction for evaluation based on hold factor, in accordance with some embodiments of the present disclosure.

According to some embodiments of the present disclosure, an interaction may arrive to the contact center system via various communication channels such as voice, chat, email and the like. When the interaction arrives via any communication channel it may be distributed via an Automatic call distributor (ACD) such as ACD 105 or any other interaction recorder to an agent and recorded by it. After the interaction with the customer ends, the metadata of the interaction may be deduced to be stored in an interaction metadata database (not shown).

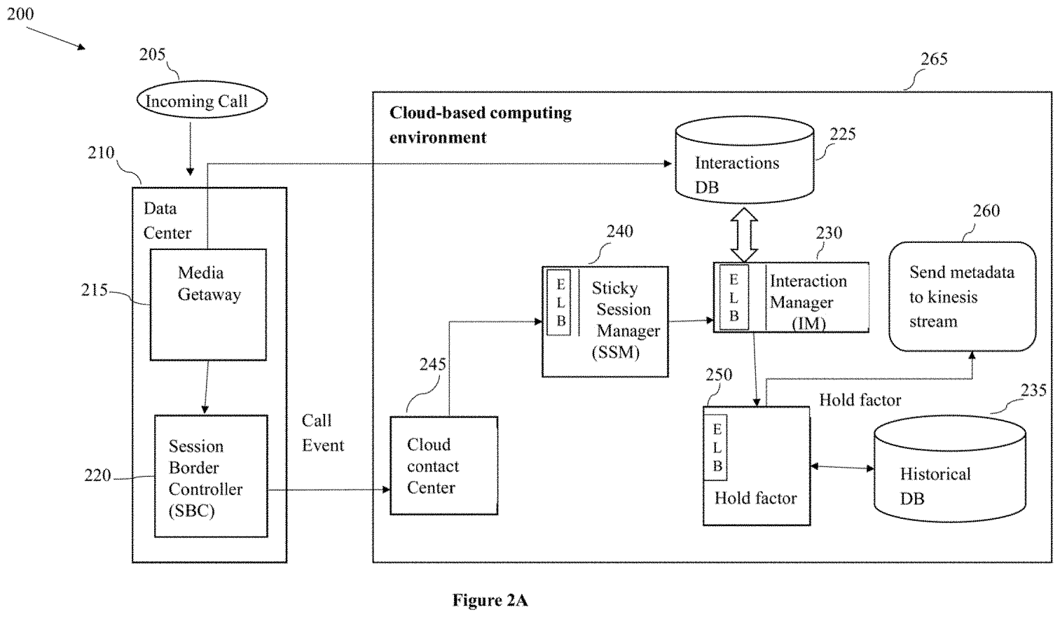

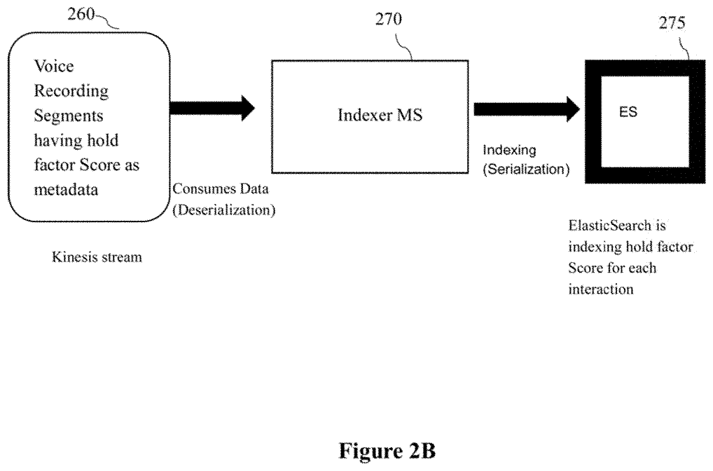

According to some embodiments of the present disclosure, after the interaction with the customer ends, the metadata of the interaction may be forwarded to a Hold Factor Calculation (HFC) model 115 such as computerized-method for calculating a hold factor of an interaction in a call center, by which related agent recording segments may be filtered for evaluation 200 in FIG. 2. The HFC model 115 may calculate hold factor according to a calculated hold ratio and a calculated conversation score.

According to some embodiments of the present disclosure, the calculation of the hold factor may be a calculated hold ratio divided by a conversation score. The hold factor value lies under the range of zero and one. A higher value of the hold factor may reflect high contact center inefficiency and also it may result in degraded customer experience.

According to some embodiments of the present disclosure, after the HFC model 115 have calculated the hold factor the hold factor may be forwarded to several components in the contact center system 100 such as Multi-Channel Recording (MCR) Indexer Micro Service (MS) 130 which may forward it to a search engine such database as an Elastic Search (ES) database 135. The ES database 135 may document oriented database which is stored inside AWS cloud.

According to some embodiments of the present disclosure, MCR search MS 120 may fetch data such as hold factor from the search engine e.g., ES 135 and may forward it to a Quality Planner (QP) MS component such as QP MS component 125. A QP MS component such as QP MS 125 is commonly used to distribute interaction recording segments across evaluators as per the configuration of a QP.

The QP MS component 125 enables quality plans management from a centralized location. These quality plans may randomly select agent recorded interactions based on predefined criteria, and then distribute those recorded interactions to evaluators for evaluation and review of agent's performance. After a quality plan is created and activated by the QP MS component 125, it may sample interactions from the agents which are defined in the quality plan and send the relevant interaction recording segments to evaluators for review. A scheduled job runs as per the configuration in the configuration file e.g., every two hours, and distributes the interaction recording segments evenly among all evaluators by existing algorithm support even distribution.

Whenever a user such as a manager creates a new quality plan then QP MS component 125 calls MCR Search MS which queries the search engine database, e.g., elastic search database 135 to get the interaction recording segments of an agent as per a date range. The QP MS component 125 may check the value of the hold factor as retrieved from the ES database 135 and then may apply a filter accordingly, to distribute the interaction recording segments among the evaluators. The filter may be a preconfigured threshold value or a range of values.

According to some embodiments of the present disclosure, before the QP MS component 125 distributes an interaction recording segments to an evaluator, it may check the hold factor of an interaction. If the hold factor is above a preconfigured threshold or in a preconfigured range of values, then the QP MS component 135 may distribute the interaction recording segments of the interaction for evaluation. The distributed interaction for evaluation may be reviewed by an evaluator for due consideration and follow-on remedial measures to enhance call centre and agent's efficiency.

According to some embodiments of the disclosure, the due consideration may be selected from at least one of: (i) identifying low level of performance of agents (ii) identifying high attrition rate; and (iii) identifying ineffective knowledge base. The follow-on remedial measures may be selected from at least one of: (i) assigning agents to a coaching plan based on the identified low level of performance; (ii) solving issues related to agents' discontent; and (iii) amending the knowledge base to be effective for the interactions.

Otherwise, if the hold factor is below the preconfigured threshold or not falling in the range of values it may not send the interaction recording segments for evaluation. Thus, interactions having a hold factor below the hold factor threshold will not be distributed for performance evaluation. In other words, interactions having a hold factor below the hold factor threshold or hold factor that is not falling in the preconfigured range may be filtered out and not sent for evaluation.

According to some embodiments, Quality planner MS 125 may use the calculated hold factor to filter out interactions from distribution for evaluation. If the hold factor is above a preconfigured threshold, then the segments of the interaction may be distributed for performance evaluation of the agent who conducted the interaction. If the hold factor is smaller than hold factor threshold i.e., below the threshold then the segments of the interaction may be discarded.

According to some embodiments of the present disclosure, a conversation score may be calculated based on agent performance and call characteristics. The calculated conversation score may be calculated as per the skill set of the agent, a call complexity and the total number of holds that have been occurred during the conversation.

According to some embodiments of the present disclosure, the conversation score may be calculated by: (i) calculating a weighted average of the collected skills of agent data fields to yield an aggregated skills score; (ii) assigning a skill-set level based on the yielded aggregated skills score according to a preconfigured table level of skill-set; (iii) calculation a weighted average of the collected interaction data fields to yield an aggregated complexity score; (iv) assigning complexity-level of the interaction based on the yielded aggregated complexity score according to a preconfigured table level of complexity; (v) calculating a total duration of allowed hold times based on the assigned score for skill-set of an agent and based on the determined complexity-level of the interaction; and (vi) summing the assigned score for skill-set of an agent, the determined complexity-level and the calculated total number of allowed hold timed to yield a conversation score.

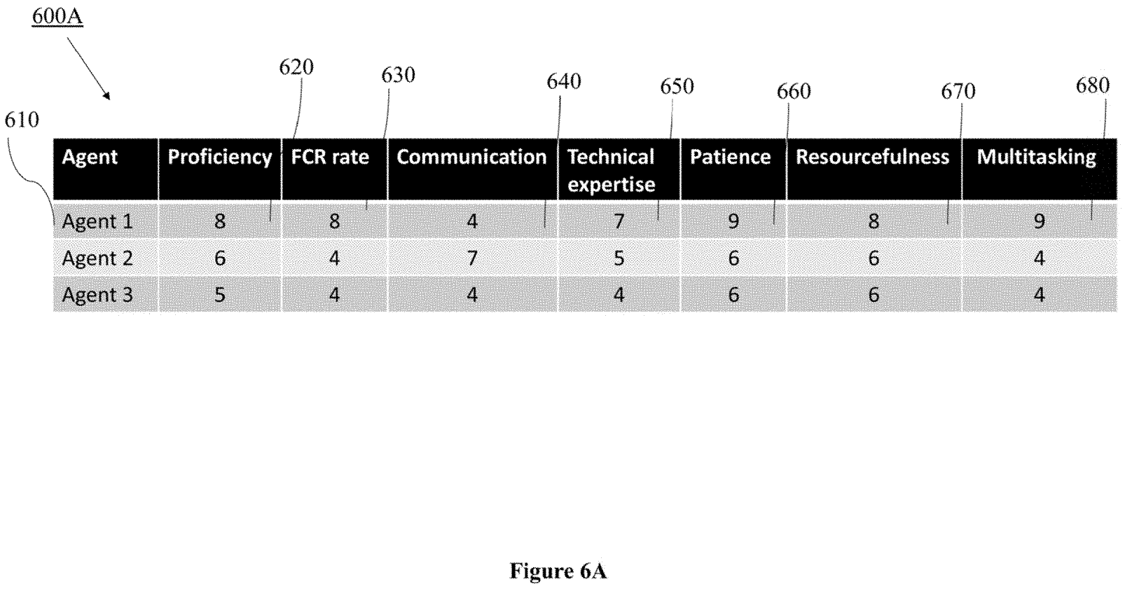

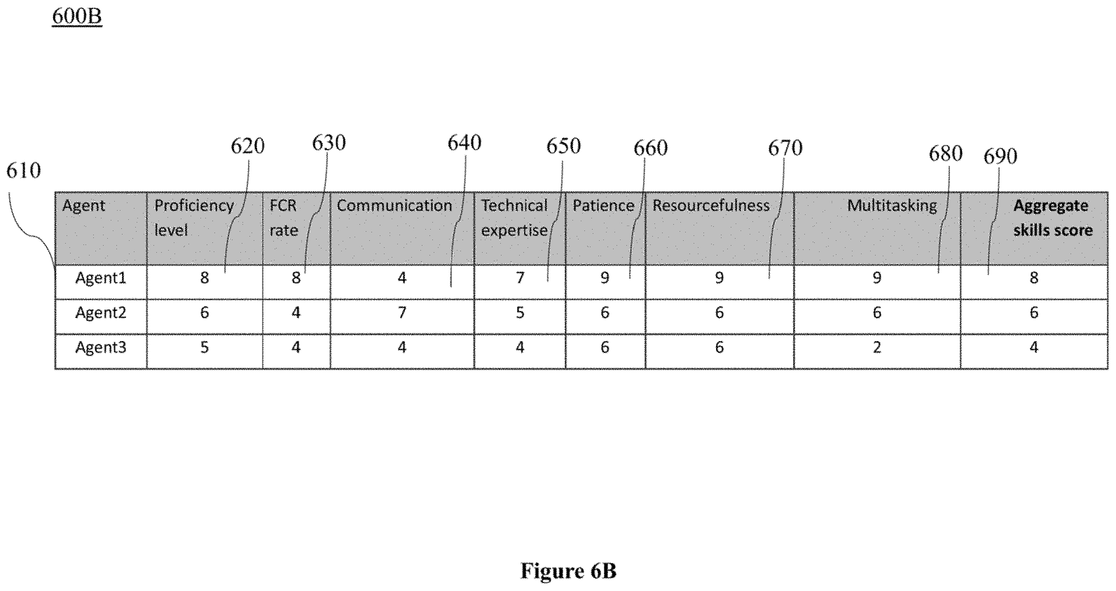

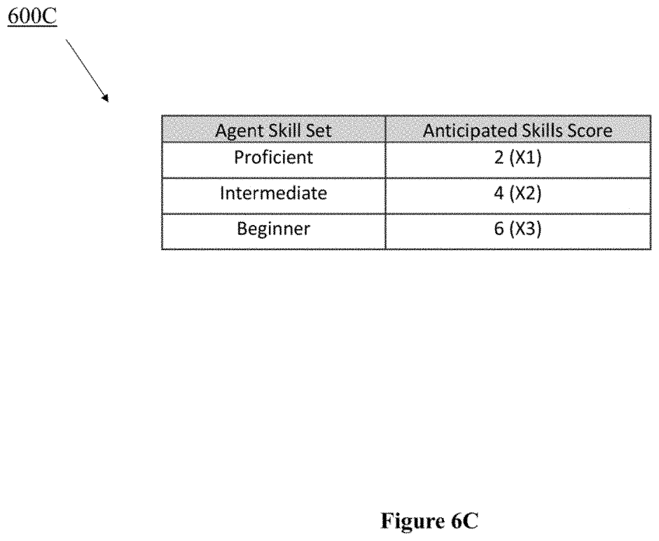

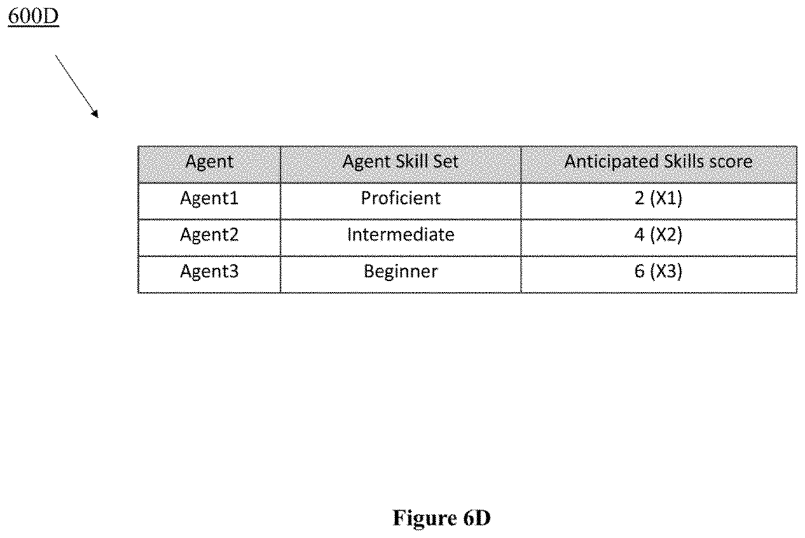

According to some embodiments of the present disclosure, the data fields related to agent's skill set may have a score in the database of historical data 235 in FIG. 2A. As shown in table 600A in FIG. 6A each agent has a score for each skill. For example, ‘agent 1’ 610 may have proficiency level score of ‘8’, designated as element 620, an First Call Resolution (FCR) rate score of ‘8’, designated as element 630, a communication score of ‘4’, designated as element 640, technical expertise score of ‘7’, designated as element 650, patience score of ‘8’, designated as element 660, resourcefulness score of ‘8’, designated as element 670 and multitasking score of ‘9’, designated as element 680.

According to some embodiments of the present disclosure, the aggregated skill score of ‘agent 1’ may be calculated a weighted average of the collected skills of agent data fields. In case all data fields have the same weight than the aggregated skills score may be the sum of data fields 620 through 680 divided by the amount of the data fields, which results in aggregated skills score ‘8’ e.g., aggregated skillset score 690 in table 600B in FIG. 6B.

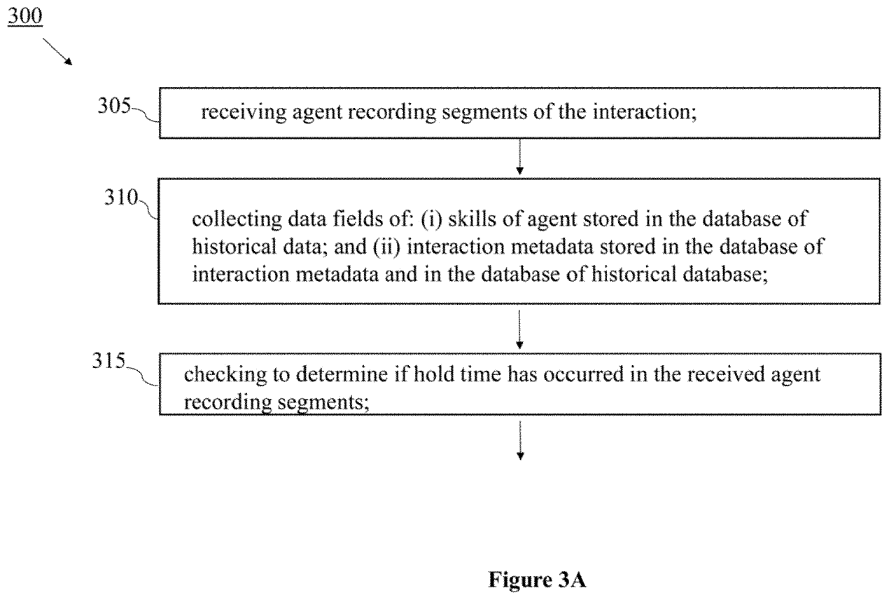

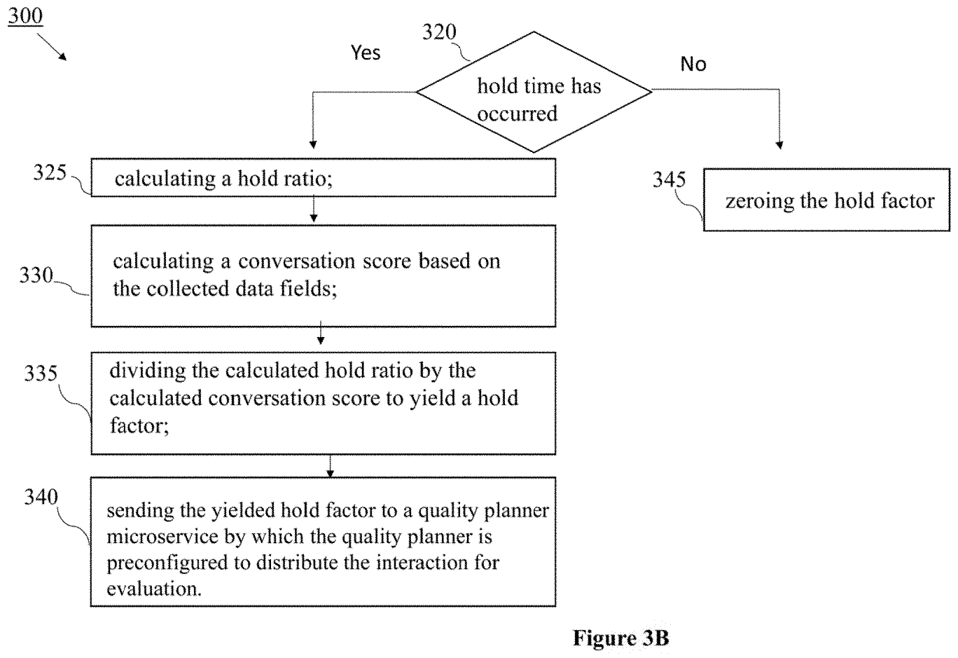

According to some embodiments of the present disclosure, the aggregated score may than be translated to a level score according to a predefined table e.g. table 600C in FIG. 6C. For example, when the skills score is kept at max score level of ‘10’ then the algorithm of assigning anticipated skill set by the HFC model, such as HFC model 300 in FIGS. 3A-3B, may be as follows: when the aggregate skills score of an agent lies between a range of 8<=aggregate score<=10 then agent skills score may be mapped to “proficient” and the skill set score may be 2. When the aggregate score of an agent lies between range of 5<=aggregate score<=7 then agent skills score will be mapped to “intermediate” and the skills score may be 4. When the aggregate skills score of an agent lies between range of 3<=aggregate score<=5 then the agent skills score may be mapped to “beginner” and the skills score may be 6.

According to some embodiments of the present disclosure, a lookup table for each agent which is mapping the skill level and the skills score may be maintained. For example, table 600D in FIG. 6D. A lookup table such as lookup table 600C in FIG. 6C and 600D in FIG. 6D may be maintained for each agent. The lookup table may be implemented as an in-memory cache that may be implemented by a hash-map structure of the programming language.

According to some embodiments of the present disclosure, the call complexity may be calculated according to the data fields of interaction which may include at least one of: Average Handling Time (AHT); timeline of customer ticket; complexity of customer questions and concerns; number of agents involved in the interaction; and other or any combination thereof.

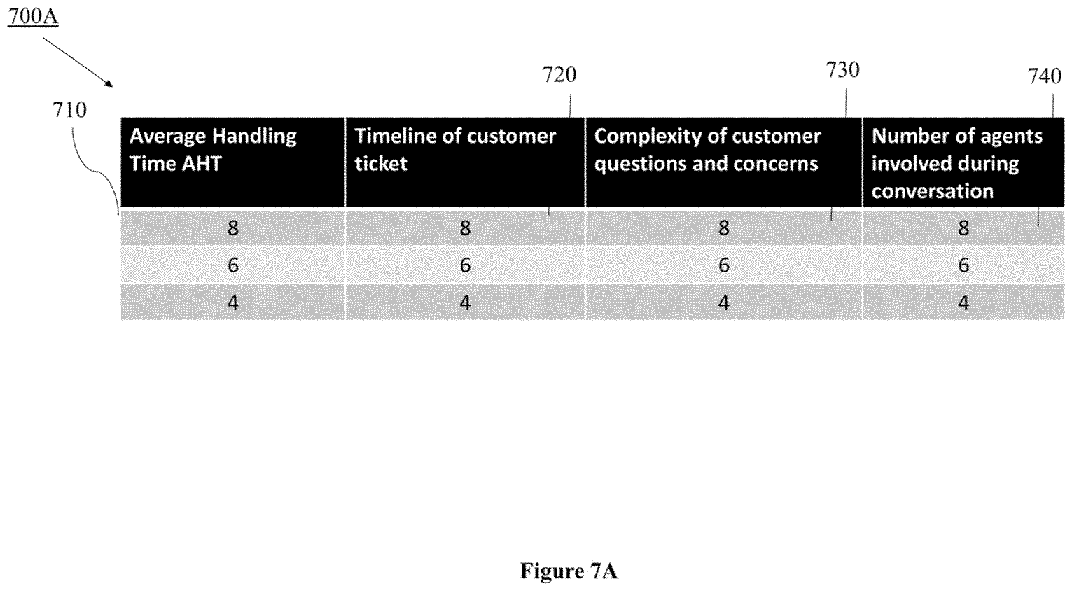

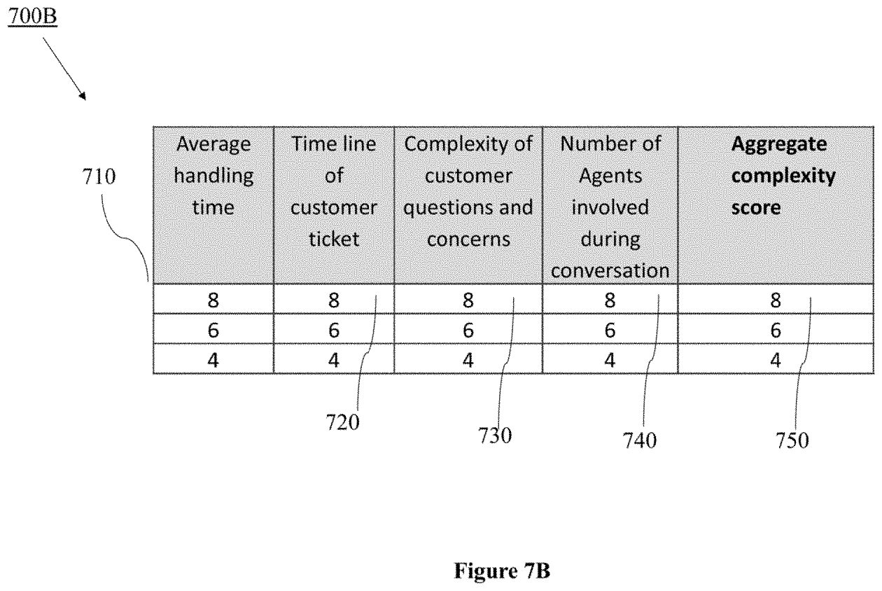

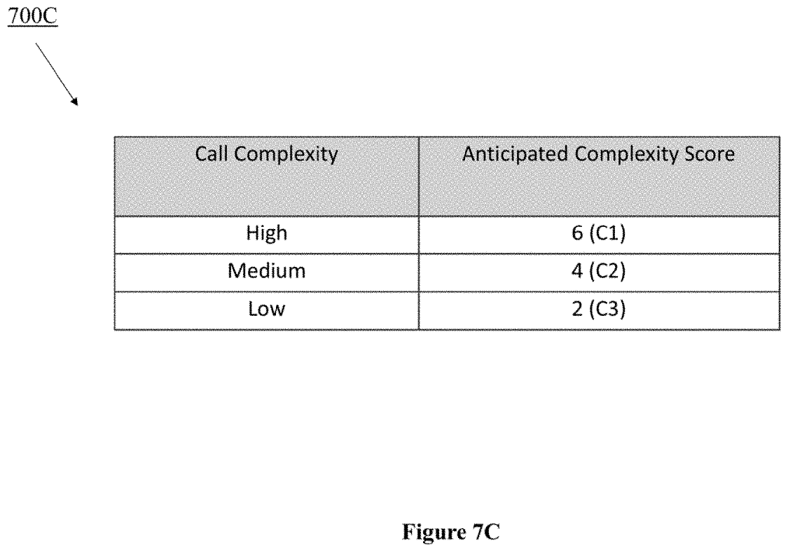

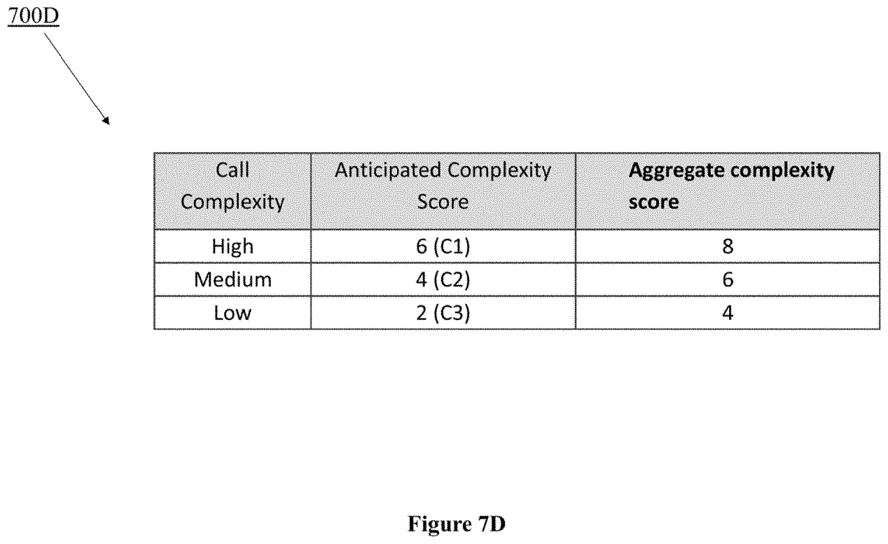

According to some embodiments of the present disclosure, the data fields related to the interaction may be retrieved from interaction database such as interaction database 225 in FIG. 2. As shown in table 700A in FIG. 7A each interaction has a score for each skill. For example, the interaction designated as element ‘710’ may have AHT score of ‘8’ designated as element 720, complexity of customer questions and concerns may have the score of ‘8’ designated as element 730, and number of agents involved during conversation score of ‘8’ designated as element 740.

Accordingly, a weighted average of the collected interaction data fields may be calculated to yield an aggregated complexity score such as aggregated complexity score 750 in FIG. 7B. In case all data fields have the same weight than the aggregated complexity score 750 in FIG. 7B may be the sum of data fields 710 through 740 divided by the amount of the data fields, which results in aggregated skills score ‘8’, 750 in FIG. 7B.

According to some embodiments of the present disclosure, the aggregated score may be then translated to a level score according to a predefined table such as table 700C in FIG. 7C. For example, when the complexity is kept at max score level of 10 then the algorithm of assigning anticipated skill set by the HFC model, such as HFC model 300 in FIGS. 3A-3B, may be as follows: when the aggregate score of call complexity lies between range of 8<=aggregate score<=10 then the call complexity may be mapped to “high” and the anticipated score may be 6. When the aggregate score of a call complexity lies between range of 5<=Aggregate Score<=7 then the call complexity may be mapped to “medium” and the anticipated score will be 4. When the aggregate score of a call complexity lies between range of 3<=aggregate score<=5 then the call complexity may be mapped to low and the anticipated score may be 2.

According to some embodiments of the present disclosure, a lookup table for each agent which is mapping the skill level and the skills score may be maintained, for example, table 700D in FIG. 7D. A lookup table such as lookup table 700C in FIG. 7C and 700D in FIG. 7D may be maintained for each interaction. The lookup table may be implemented as an in-memory cache that may be implemented by a hash-map structure of the programming language.

FIGS. 2A-2B is a diagram of a system 200 for calculating a hold factor of an interaction in a call center, by which related agent recording segments may be filtered for evaluation, according to some embodiments of the disclosure.

According to some embodiments of the present disclosure, a Data Center (DC) 210 may comprise session recording components. The DC 210 may comprise: a Media Gateway 215 and a Session Border Controller (SBC) 220. The media gateway 215 may be configured for transmitting telephone calls between an Internet Protocol (IP) network and traditional analog facilities of the Public Switched Telephone Network (PSTN). In other words, the media gateway 215 may be configured for converting incoming signal into a relevant SIP format and provide this information to SBC 220.

According to some embodiments of the present disclosure, data center 210 may be connected to a cloud-based computing environment 265. The cloud-based computing environment may be Amazon Web Services (AWS).

According to some embodiments of the present disclosure, the Session Border Controller (SBC) 220 may be configured to protect and regulate IP communications flows. The SBC 220 may be deployed at network borders to control IP communications sessions. It is used to regulate all forms of real-time communications including VoIP, IP video, text chat and collaboration sessions. Furthermore, the SBC 220 may manipulate IP communications signaling and media streams, and providing a variety of functions including: security, multivendor interoperability, protocol interworking, Quality of Service and session routing.

According to some embodiments of the present disclosure, a cloud-based center 245 such as inContact core may be hosted in a cloud-based computing environment such as Amazon Web Services (AWS) and may be responsible for retrieving Computer Telephone Integration (CTI) event from an SBC such as SBC 220.

According to some embodiments of the present disclosure, when a new call interaction arrives in the contact center then, a cloud based center 245, e.g., a contact core service may send a new Computer Telephony Integration (CTI) event to a generic router such as Sticky Session Manager (SSM) 240 as received from the SBC 220 and it may route the event to an Interaction Manger (IM) 230.

According to some embodiments of the present disclosure, the IM 230 may manage the state of every CTI event and may send state to a task manager microservice and also may send a recording request to the relevant recorder. Once the interaction is finished, the IM 230 may send the agent recording segments of the interaction to the Kinesis Data Stream (KDS).

According to some embodiments of the present disclosure, an Interaction Manager (IM) such as IM 230 may get call detail records for the completed calls from the table-oriented database 225. The interactions database 225 may be for example, a table-oriented database such as MySQL database.

According to some embodiments of the present disclosure, the IM 230 may send the interaction detail records along with the retrieved data through Representational State Transfer (REST) Application Programming Interface (API) to a hold factor model. The hold factor model may be a Hold Factor Calculation (HFC) model 250 such as HFC model 300 in FIGS. 3A-3B for calculating a hold factor of an interaction in a call center, by which related agent recording segments may be filtered for evaluation.

According to some embodiments of the present disclosure, the HFC model 250 may calculate the hold factor based on interaction metadata and historical data. Once an interaction ends the HFC model 250 may prepare a data model such as JSON object which includes a hold factor and may send the data over to a kinesis stream 260 such as Amazon KDS.

According to some embodiments of the present disclosure, system 200 may include an Indexer Micro-Service (MS) 270. The Indexer MS 270 may be configured to listen to real time data streaming service and when new metadata arrives it may index and store the metadata related to calculated hold factor of an interaction into a database such as a document-oriented database (not shown).

According to some embodiments of the present disclosure, as part of Micro Service Architecture (Representational State Transfer (REST) API), the indexed data may be further retrieved from the database such a document-oriented database to retrieve the hold factor of the recorded call interaction.

According to some embodiments of the present disclosure, the Multi-Channel Recording (MCR) unit such as MCR 120 in FIG. 1 may be configured to retrieve: an interaction call; and indexed metadata from a document-oriented database such as database 135 in FIG. 1 related to the hold factor of the recorded call interaction, according to a predefined quality plan created via Quality Planner Micro-Service 125 in FIG. 1.

According to some embodiments of the present disclosure, the elastic search database such as database 135 in FIG. 1 may maintain the recording metadata in a JSON format. The indexer micro service, such as indexer MS 270 in FIG. 2, may keep listening, to the Kinesis stream 260 in FIGS. 2A-2B continuously. Once the data is read from the Kinesis stream, it may be validated and processed and then it may be indexed in the elastic search database, such as ES database 135 in FIG. 1, indices. The indexer service such as indexer MS 270 in FIG. 2 may support time-based multi-indices in the elastic search database.

According to some embodiments of the present disclosure, indexer MS 270 in FIG. 2 may index the call records by using index API and after then for each call record there will be a hold factor available inside the elastic search database such as ES database 135 in FIG. 1.

According to some embodiments of the present disclosure, the QP MS 125 in FIG. 1 may fetch the data from ES database 135 in FIG. 1 as per the plan duration of recorded segments, QP MS may check the hold factor range provided by the manager i.e., preconfigured by the manager, and accordingly provide a filtered input to the MCR Search MS 120 in FIG. 1 and MCR search MS 120 in FIG. 1 may fetch the recorded segment from the ES database 135 in FIG. 1 and may provide response to QP MS 125 in FIG. 1. Thus, the QP MS 125 in FIG. 1 may distribute such recorded segments along with hold factor information to the evaluator which will be utilized by the evaluator for the evaluation of such segment

FIGS. 3A-3B high-level workflow of Hold Factor Calculation (HFC) model 300 for calculating a hold factor of an interaction in a call center, by which related agent recording segments may be filtered for evaluation, in accordance with some embodiments of the present disclosure.

According to some embodiments of the present disclosure, operation 305 may comprise receiving agent recording segments of the interaction.

According to some embodiments of the present disclosure, operation 310 may comprise collecting data fields of: (i) skills of agent stored in the database of historical data; and (ii) interaction metadata stored in the database of interaction metadata and in the database of historical database.

According to some embodiments of the present disclosure, operation 315 may comprise checking to determine if hold time has occurred in the received agent recording segments.

According to some embodiments of the present disclosure, operation 320 may comprise when it is determined that hold time has occurred operating operations 325 through 340. When it is determined that hold time has not occurred operating operation 345.

According to some embodiments of the present disclosure, operation 325 may comprise calculating a hold ratio.

According to some embodiments of the present disclosure, operation 330 may comprise calculating a conversation score based on the collected data fields.

According to some embodiments, operation 335 may comprise dividing the calculated hold ratio by the calculated conversation score to yield a hold factor.

According to some embodiments of the present disclosure, operation 340 may comprise sending the yielded hold factor to a quality planner microservice by which the quality planner is preconfigured to distribute the interaction for evaluation.

According to some embodiments of the present disclosure, operation 345 may comprise zeroing the hold factor.

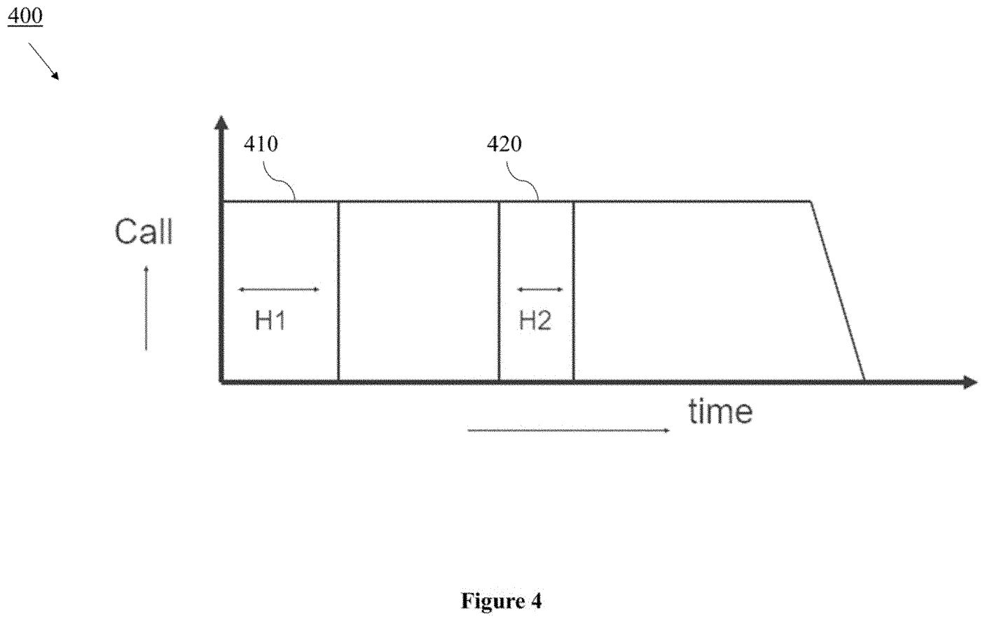

FIG. 4 schematically illustrates a calculation of hold ratio 400, in accordance with some embodiments of the present disclosure.

According to some embodiments of the present disclosure, HFC model such as HFC model 300 in FIGS. 3A-3B may identify one or more hold times in each segment of the received agent recording segments to measure a duration of each identified hold time and to sum the measured duration of the one or more hold times to a total hold time during the interaction.

For example, a first hold duration 410 may be taken by the agent during the interaction for example to look up for an answer in a knowledge base of the contact center. Later on, a second hold duration 420 may be taken by the agent during the interaction for example, to consult with the supervisor as to a request of the caller.

According to some embodiments of the present disclosure, HFC model 300 in FIGS. 3A-3B may be configured to measure a total duration of the received agent recording segments of the interaction and then to calculate a hold ratio by dividing the total hold time by the total duration.

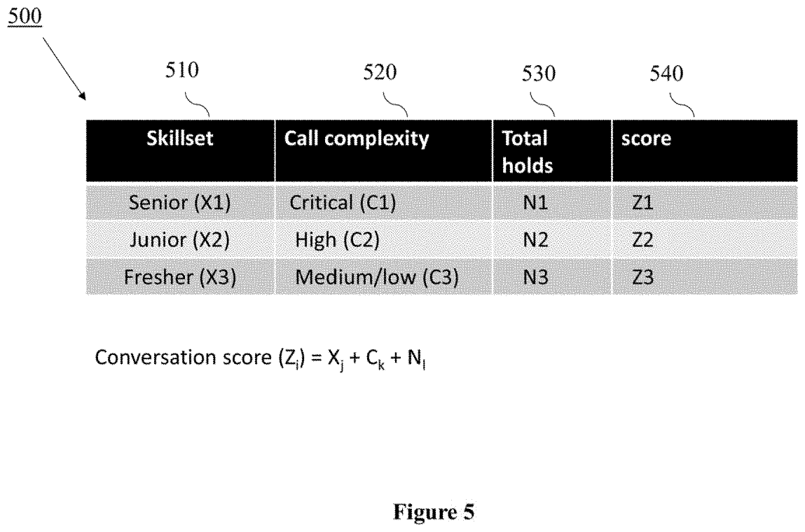

FIG. 5 a table illustrating parameters for calculation of a conversation score 500 based on agent and interaction characteristics, according to some embodiments of the present disclosure.

According to some embodiments of the present disclosure, HFC model 300 in FIGS. 3A-3B may be configured to calculate a conversation score based on collected data fields. The calculation of the conversation score may be performed by calculating a level of skill set of the agent 510, the level of complexity of the interaction 520 and the total duration of the hold time 530 to yield a total score 540.

The level pf skill set of the agent 510 may be calculated by a weighted average of the collected skills of agent data fields to yield an aggregated skills score and then assigning a skill-set level based on the yielded aggregated skills score according to a preconfigured table level of skill-set. For example, “senior”, “junior” or “fresher”.

The level of complexity of the interaction 520 may be calculated by HFC model 300 in FIGS. 3A-3B by calculating a weighted average of the collected interaction data fields to yield an aggregated complexity score and assigning complexity-level of the interaction based on the yielded aggregated complexity score according to a preconfigured table level of complexity. For example, “critical”, high”, “medium/low”.

The total hold time may be calculated by HFC model 300 in FIGS. 3A-3B by calculating a total duration of allowed hold times based on the assigned score for skill-set of an agent and based on the determined complexity-level of the interaction and summing the assigned score for skill-set of an agent, the determined complexity-level and the calculated total number of allowed hold time to yield a conversation score 540.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

1. A computerized-method for calculating a hold factor of an interaction in a call center, by which related agent recording segments may be filtered for evaluation, the computerized-method comprising:
in a computerized system comprising a processor, a database of historical data related to interaction metadata and skills of agent, a database of interaction metadata; a memory to store the plurality of databases, said processor is configured to operate a Hold Factor Calculation (HFC) model for an interaction, said operating of HFC model comprising:
(i) receiving agent recording segments of the interaction after the interaction has ended;
(ii) collecting data fields of: (a) skills of agent stored in the database of historical data; and (b) interaction metadata stored in the database of interaction metadata and in the database of historical database;
(iii) checking to determine if hold time has occurred in the received agent recording segments;
when it is determined that hold time has occurred:
(iv) calculating a hold ratio;
(v) calculating a conversation score based on the collected data fields;
(vi) dividing the calculated hold ratio by the calculated conversation score to yield a hold factor; and
(vii) sending the yielded hold factor to a quality planner microservice by which the quality planner is preconfigured to distribute the interaction for evaluation,
wherein, when it is determined that hold time has not occurred hold factor is zeroed.

2. The computerized-method of claim 1, wherein the hold ratio is calculated by:
(a) identifying one or more hold times in each segment of the received agent recording segments to measure a duration of each identified hold time and to sum the measured duration of the one or more hold times to a total hold time in the interaction;
(b) measuring a total duration of the received agent recording segments of the interaction; and
(c) calculating a hold ratio by dividing the total hold time by the total duration.

3. The computerized-method of claim 1, wherein the conversation score is calculated by:
(a) calculating a weighted average of the collected skills of agent data fields to yield an aggregated skills score;
(b) assigning a skill-set level based on the yielded aggregated skills score according to a preconfigured table level of skill-set;
(c) calculation a weighted average of the collected interaction data fields to yield an aggregated complexity score;
(d) assigning complexity-level of the interaction based on the yielded aggregated complexity score according to a preconfigured table level of complexity;
(e) calculating a total duration of allowed hold times based on the assigned score for skill-set of an agent and based on the determined complexity-level of the interaction; and
(f) summing the assigned score for skill-set of an agent, the determined complexity-level and the calculated total number of allowed hold time to yield a conversation score.

4. The computerized-method of claim 3, wherein the data fields of skills of agent includes at least one of:
proficiency level;
First Call Resolution (FCR) rate;
technical expertise;
patience;
resourcefulness;
multitasking; and any combination thereof.

5. The computerized-method of claim 3, wherein the data fields of interaction includes at least one of:
Average Handling Time (AHT);
timeline of customer ticket;
complexity of customer questions and concerns;
number of agents involved in the interaction; and any combination thereof.

6. The computerized-method of claim 1, wherein the distributed interaction for evaluation is reviewed by an evaluator for due consideration and follow-on remedial measures to enhance call center and agent's efficiency.

7. The computerized-method of claim 6, wherein the due consideration is selected from at least one of: (a) identifying low level of performance of agents; (b) identifying high attrition rate; and (c) identifying ineffective knowledge base.

8. The computerized-method of claim 6, wherein the follow-on remedial measures are selected from at least one of: (a) assigning agents to a coaching plan based on the identified low level of performance; (b) solving related issues to agents discontent; and (c) amending the knowledge base to be effective for the interactions.

9. The computerized-method of claim 1, wherein the yielded hold factor is a value between zero and one, and wherein when the value is closer to one it is an indication that the call center is not efficient.

10. A computerized-system for calculating a hold factor of an interaction in a call center, by which related agent recording segments may be filtered for evaluation, the computerized-system comprising:
a database of historical data related to interactions and skills of agent;
a database of interaction metadata;
a memory to store the plurality of databases; and
a processor, said processor is configured to operate a Hold Factor Calculation (HFC) model for an interaction, said operating of HFC model comprising:
(i) receiving agent recording segments of an interaction after the interaction has ended;
(ii) collecting data fields of: (a) skills of agent stored in the database of historical data; and (b) interaction metadata stored in the database of interaction metadata and in the database of historical database;
(iii) checking to determine if hold time has occurred in the received agent recording segments;
when it is determined that hold time has occurred:
(iv) calculating a hold ratio;
(v) calculating a conversation score;
(vi) dividing the calculated hold ratio by the calculated conversation score to yield a hold factor; and
(vii) sending the yielded hold factor to a quality planner microservice by which the quality planner is preconfigured to distribute the interaction for evaluation,
wherein, when it is determined that hold time has not occurred hold factor is zeroed.

11. The computerized-system of claim 10, wherein the hold ratio is calculated by:
(a) identifying one or more hold times in each segment of the received agent recording segments to measure a duration of each identified hold time and to sum the measured duration of the one or more hold times to a total hold time in the interaction;
(b) measuring a total duration of the received agent recording segments of the interaction; and
(c) calculating a hold ratio by dividing the total hold time by the total duration.

12. The computerized-system of claim 10, wherein the conversation score is calculated by:
(a) calculation a weighted average of the collected skills of agent data fields to yield an aggregated skills score;
(b) assigning a skill-set level based on the yielded aggregated skills score according to a preconfigured table level of skill-set;
(c) calculation a weighted average of the collected interaction data fields to yield an aggregated complexity score;
(d) assigning complexity-level of the interaction based on the yielded aggregated complexity score according to a preconfigured table level of complexity;
(e) calculating a total duration of allowed hold times based on the assigned score for skill-set of an agent and based on the determined complexity-level of the interaction; and
(f) summing the assigned score for skill-set of an agent, the determined complexity-level and the calculated total number of allowed hold time to yield a conversation score.

13. The computerized-system of claim 12, wherein the data fields of skills of agent includes at least one of:
proficiency level;
First Call Resolution (FCR) rate;
technical expertise;
patience;
resourcefulness;
multitasking; and any combination thereof.

14. The computerized-system of claim 12, wherein the data fields of interaction includes at least one of:
Average Handling Time (AHT);
timeline of customer ticket;
complexity of customer questions and concerns;
number of agents involved in the interaction; and any combination thereof.

15. The computerized-system of claim 10, wherein the distributed interaction for evaluation is reviewed by an evaluator for due consideration and follow-on remedial measures to enhance call center and agent's efficiency.

16. The computerized-system of claim 15, wherein the due consideration is selected from at least one of: (a) identifying low level of performance of agents; (b) identifying high attrition rate; and (c) identifying ineffective knowledge base.

17. The computerized-system of claim 14, wherein the follow-on remedial measures are selected from at least one of: (a) assigning agents to a coaching plan based on the identified low level of performance; (b) solving related issues to agents discontent; and (c) amending the knowledge base to be effective for the interactions.

18. The computerized-system of claim 10, wherein the yielded hold factor is a value between zero and one, and wherein when the value is closer to one it is an indication that the call center is not efficient.
